(19) United States
(12) Patent Application Publication
(10) Pub. No.: US 2009/0224544 A1
(43) Pub. Date: Sep. 10, 2009

(54) Integrated turbine alternator/generator

(76) Inventor: James William Bartlett, Fredericksburg, VA (US)

Correspondence Address: James W. BARTLETT, 1231 Jefferson Davis Hwy #117, Fredericksburg, VA, 22401, US

(21) Appl. No.: 12/290,045

(22) Filed: Oct. 27, 2008

Related U.S. Application Data
(60) Provisional application No. 60/996,682, filed on Nov. 30, 2007.

(51) Int. Cl. H02K 7/18

(52) U.S. Cl. 290/52

(57) ABSTRACT

A Integrated Turbine Alternator/Generator for the generation of electricity wherein the stator is integral to the outer shell or housing of the unit and the armature is integral to an internal, bladed assembly. Upon action of a force or forces against the blade assembly, the integral armature is spun, carrying coils or magnets past a stator of coils or magnets and electricity is produced.

### BACKGROUND

1. Field of Invention

The present invention relates to turbines used in the generation of electricity and more particularly relates to utilization of basic turbine structure mated with the armature and stator mechanisms as a component of the turbine vs. an attachment to it, and is related to generation of power across a full spectrum wherever wind, water or heat energy can be directed through the turbine causing its armature component, directly attached to the blade structure, to rotate and produce electricity along the full length of the device.

2. Description of Prior Art

The basic cylindrical turbine utilizing internal blades to drive it is not new and is by no means uncommon. In this case, however, the integration of the actual generating components into the turbine body and internal drive train substantially departs from the conventional concepts of construction and deployment of turbine devices and alternator/generators. By combining the elements of drive and electrical generation into a single unit great advantages in efficiency, size and potential deployments can be achieved far and above the traditional approach of a separate driving element connected by shaft, belt, chain or separate means to the generating component.

### SUMMARY OF THE INVENTION

The device is a power generating unit constructed in a similar fashion to turbine units is general use, which have outer cylindrical or even ring shaped bodies that act as the outer housing for the turbine blade assembly, but whereby the copper coils required to generate electricity are fitted along this outer housing, thus creating an integrated cylindrical or ring stator assembly with the coils running the majority of the height/length of the cylinder (or ring) housing.

Inside, deployed as an integral part of the normal turbine blade assembly, is arranged the armature holding the necessary magnets on either a separate cylinder or ring or by a framework approximating a cylinder or ring to which the blades are attached. Upon input of energy against the blades, the armature turns in an arc closely aligned with the outer, stator cylinder and thus produces electricity. Circular movement of the armature is facilitated by placement of bearings either along the outer circumference of the bladed armature cylinder/ring or on a central shaft that secures a supporting framework for the bladed armature.

The device differs from traditional alternators or generators, however, in that the coils and armature components are integral to the base unit and extend along the majority of the height/length of the cylinders or rings and their arrangement leaves a clear path through the center of the device that is fitted with turbine blades and through which the air/gas, liquid or heat energy that drives the blades passes.

The basic construction of the device is thus a machine in which the generating components and the drive mechanism and cylindrical housing of the turbine are integrated, thus eliminating the need for an external and separate generating unit to be coupled to the turbine.

This addresses several problem issues in both the realm of power generation and the operation of standard turbines. With the former, the generating unit can be constructed in any number of sizes and lengths and still retain maximum desired output in a wide range of environmental settings. In the latter, the need for a separate generating device driven by a stand alone turbine is eliminated, thus making the unit more compact and eliminating efficiency loss due to mechanical linkages or shafts.

### DESCRIPTIONS OF THE DRAWINGS

The invention will be better understood when consideration of the detailed description. Such description makes reference to the following annexed drawings wherein:

FIG. 1 is a representation of the outside core of the turbine containing the stator, in this case coil windings.

FIG. 2. is a representation of the inner armature assembly, showing the turbine drive blades, framework housing them and in this case magnets as the outer edge of the armature.

FIG. 3. is a representation of the assembled components showing generally the assembled device with outer stator assembly and inner armature assembly.

FIG. 4 is a representation of the assembled component without the turbine blades blocking the view of the outer armature assembly, in this case representative of magnets. A cooling fin is represented at the top.

### DETAILED DESCRIPTION OF THE INVENTION

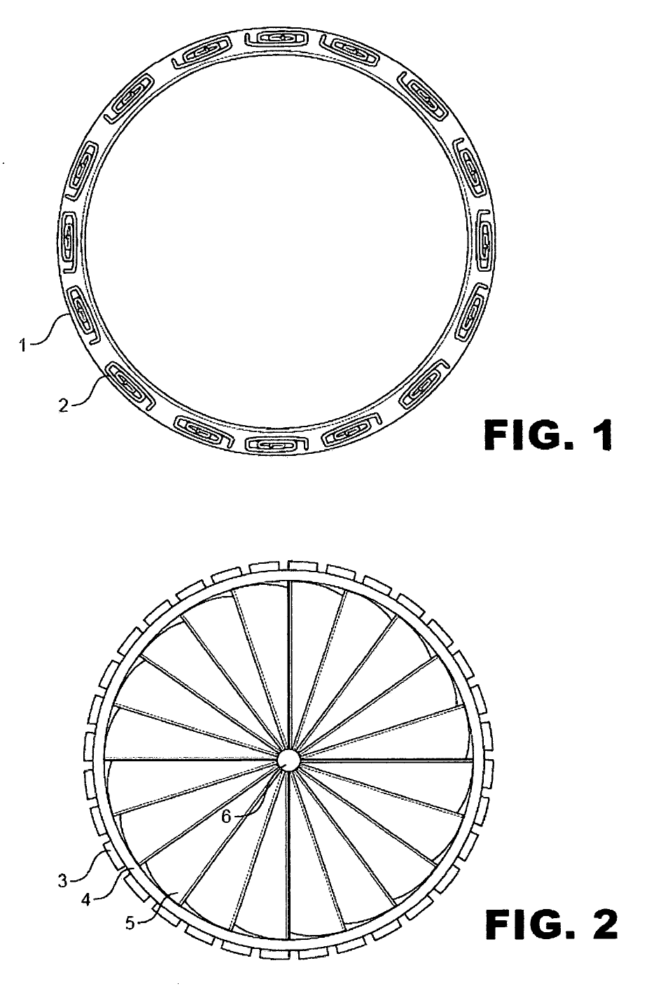

With reference now to the drawings, the Integrated Turbine Alternator will be described generally in FIGS. 1-3.

In FIG. 1 we see, in a general aspect, the outside circumference of the turbine assembly which houses the stator wiring. As mentioned, the key feature of this component is that the stator windings (FIG. 1 Item 2) are an integral part of the cylinder wall (FIG. 1 Item 1) that makes up the outside of the turbine's flow area circumference. Depending on specific application, the component could be manufactured to any length or width desired. It can also be manufactured from any number of metal or polymer materials to meet the requirements of a specific application. While an application may be manufactured in such a way as to not require shielding from the elements, most probably a constant in the majority of the manufacture would be a weather or liquid resistant coating that seals off and protects the wiring from the elements. This will most usually be a polymer such as Polyurea or a resin based compound. In this way the application can be installed in an environment exposed to the elements.

In FIG. 2 we see, in a general aspect, the bladed armature assembly which is comprised of the magnets (FIG. 2. Item 3) necessary for generation, the turbine blades (FIG. 2. Item 5) necessary for driving the armature, which are both mounted to a structure that facilitates accommodation for the two elements (FIG. 2. Item 4) around a central shaft (FIG. 2. Item 6). An alternative to a central shaft could be found if a bearing assembly that facilitates the turning of the armature were located along the outside circumference of the armature assembly.

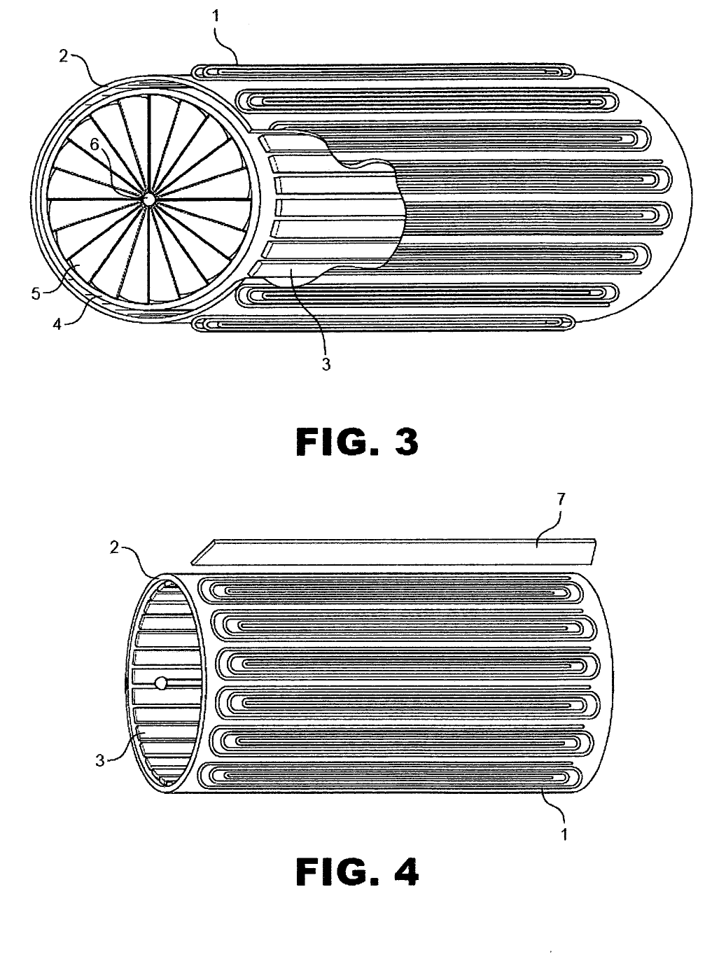

As seen in FIG. 3, once assembled the turbine unit functions much as they all do as force of one kind or another acts upon the blades, spinning the armature assembly. As the magnets on the armature assembly pass by the coils housed in the stator assembly, electricity is produced.

Downstream from the electrical generation taking place in the overall assembly, various means will be employed to condition, direct or manipulate the electricity into the required output parameters. Issues of heat generated by the process are largely addressed by the fact that air or water is flowing through and around the unit itself. If further heat management is required, cooling fins (FIG. 4 Item 7), heat sinks or other temperature control actions can be employed as needed.

That the polymer coating around the coils themselves is largely chosen for its heat resistant properties, a great deal of this issue is addressed in the basic construction if such a coating were applied.

Specific materials used in the construction of these units will vary according to application and could range from the heaviest industrial metals and alloys to lightest aerospace materials and polymers. End product materials are specific to the intended mission.

Because of its basic design and principle of operation, the device can be manufactured to almost any size specification. In this way, the device could be constructed to any scale ranging from an industrial size generation turbine down to a miniaturized, self contained power source for the smallest applications using air/gas, liquid or heat flow to drive the device. This aspect applies to length as well as width.

### Reference Numerals

1. Outer turbine wall or housing.

2. Stator (in this case coils).

3. Outer component of internal armature (in this case a magnet).

4. Inner wall or housing of the armature assembly.

5. Turbine blade.

6. Center axis of the turbine blades.

7. Cooling fin.

### Operation

Envisioned uses include any application where the requirement for power generation could be addressed by air, liquid or heat passing through the device, engaging the blades contained in the armature assembly in the center, causing the armature to spin and producing electricity. This is especially envisioned in the transportation sector where such an integrated generating turbine would be used to generate power from the slipstream of a machine in motion in settings where external bladed wind driven units would pose a safety hazard or be impractical. This could be applied in settings ranging from industrial scale, electrically driven trains to consumer scale hybrid automobiles to light aviation assets such as drones.

It is also especially envisioned in a hydro-electric setting whereby the unit could be simply placed into a moving body of water with minimal if any structural build out to support the device. In a camping or remote military area this is a decided advantage. At the same time, it could also be built to a scale that enables the device or devices to be deployed into moving bodies of water such as rivers and generate electricity on an industrial scale.

Therefore, the foregoing is considered as illustrative of the principles of the invention. Further, since numerous modifications and changes will readily occur to those skilled in the art, as the mission application dictates, it is not desired to limit the invention to the exact construction and uses outlined herein, and accordingly all suitable modifications and equivalents may be resorted to, falling within the scope of the invention.

What is claimed:

1. An integrated electrical generating turbine comprising, in combination:
A. An outer, cylindrical or ring shaped body wherein the stator is integral to the housing or body, with coils or magnets generally running the length of this outer body or housing.
B. An inner, integrated and bladed armature component which spins along a central axis thus propelling the magnet or coil component of the armature past the stator when flow is directed through the blades.
C. A combined, turbine unit wherein force of various kinds, passing through the center of the turbine, thus causing the blades to turn and thus propelling the armature past the stator produces electricity, this action and result being carried out in one whole unit.
